(19) United States
(12) Patent Application Publication
(10) Pub. No.: US 2025/0262036 A1
(43) Pub. Date: Aug. 21, 2025

(54) INJECTION-MOLDED PARTIAL DENTURE APPLIANCES

(71) Applicant: Zima International, Inc. d/b/a Dandy, New York, NY (US)

(72) Inventors: Kenn Butler, New York, NY (US); Samuel Wainwright, New York, NY (US); Noah Sims, New York, NY (US)

(21) Appl. No.: 18/442,891

(22) Filed: Feb. 15, 2024

(51) Int. Cl. A61C 13/01; A61C 13/08; A61C 13/10; A61C 13/34; B33Y 80/00

(52) U.S. Cl. CPC A61C 13/04; A61C 13/08; A61C 13/1003; A61C 13/34; B33Y 80/00

(57) ABSTRACT

A method according to the disclosure herein includes producing, via additive manufacturing, a first mold portion having a first recess based on a tooth portion of a patient mouth; producing, via additive manufacturing, a second mold portion having a second recess based on a gum portion of the patient mouth; positioning at least one artificial tooth in the first recess; aligning the first mold portion with the second mold portion to form a mold assembly having a cavity defined by the first recess and the second recess; filling the cavity with a resin; and removing a partial denture from the mold, the partial denture formed by the resin and the at least one artificial tooth.

### BACKGROUND

Partial dentures are dental appliances that may be worn by a patients who are not fully-edentulous in order to replace one or more teeth missing amidst an otherwise-complete set.

### BRIEF DESCRIPTION OF THE DRAWINGS

FIG. 1 is a perspective view of a mold for forming a partial denture.

FIG. 2 is a perspective view of a base of the mold of FIG. 1.

FIG. 3 is a top view of the base of FIG. 2.

FIG. 4 is a perspective view of a top of the mold of FIG. 1.

FIG. 5 is a bottom view of the top of FIG. 2.

FIG. 6 is a section view of the mold of FIG. 1 taken along line 6-6 in FIG. 1.

FIG. 7 is a section view of the mold of FIG. 1 taken along line 7-7 in FIG. 1.

FIG. 8 is a perspective exploded view of the mold of FIG. 1.

FIG. 9 is a front exploded view of the mold of FIG. 1.

FIG. 10 is a series of images illustrating a use of the mold of FIG. 1.

### DETAILED DESCRIPTION

Reference will now be made in detail to various embodiments, examples of which are illustrated in the accompanying drawings. While this disclosure includes certain embodiments, it will be understood the disclosure is not intended to limit the claims to these embodiments. On the contrary, the disclosure is intended to cover alternatives, modifications and equivalents, which may be included within the spirit and scope of the claims. Furthermore, in this detailed description, numerous specific details are set forth in order to provide a thorough understanding. However, one of ordinary skill in the art will appreciate that the subject matter of the present disclosure may be practiced without these specific details. In other instances, well known methods, procedures, and components have not been described in detail as not to unnecessarily obscure aspects of the present disclosure.

Dentures are a removable dental appliance that functionally and cosmetically replace a patient's missing teeth. The most common type of denture is a “full” denture that includes a full set of teeth and are usable (e.g., wearable) by an edentulous (e.g., toothless) jaw. Patients that are not missing an entire set of teeth are unable to wear such a full denture and conventionally have gone without replacement teeth or have made use of individual implants to replace individual teeth. However, the process of installing individual implants can be painful and costly—particularly if the patient is missing multiple teeth.

A more recent solution to this problem is a “partial” denture that fits around a patient's existing teeth. While partial dentures do functionally and cosmetically replace a patient's teeth, they are complicated and expensive to make due to the level of precision required to neatly fit the partial denture to seamlessly incorporate artificial teeth amidst a patient's natural teeth. A less-than-precise partial denture can cause health issues for a patient, as abrasions between the poorly-fit denture and the patient's natural teeth can cause pain and become infected. Aesthetically, a poorly-fit partial denture can even be less-desirable than no denture, which can be frustrating for both patient and technicians.

Various embodiments of this disclosure provide for a bespoke mold for a partial denture that utilizes dental impressions (e.g., traditional impressions from putty, digital impressions using a scanning wand, etc.), additive manufacturing, and injection molding to create a partial denture that is customized for a particular user and reduces (if not eliminates) the strenuous fitting process of conventional partial dentures. In particular, the bespoke mold of the present disclosure includes a top and a base that are additively-manufactured (e.g., 3D-printed with a materials printer) based on the negative space of a patient's mouth. The two mold parts, when mated, define a cavity shaped to hold one or more artificial teeth. The cavity is then filled with a resin (or other material suitable for use as a denture), and the resultant partial denture can be removed from the mold. Because the mold is printed based on an impression of the patient's mouth and because the artificial teeth are surrounded by the resin, the fit of the partial denture is unique to the patient.

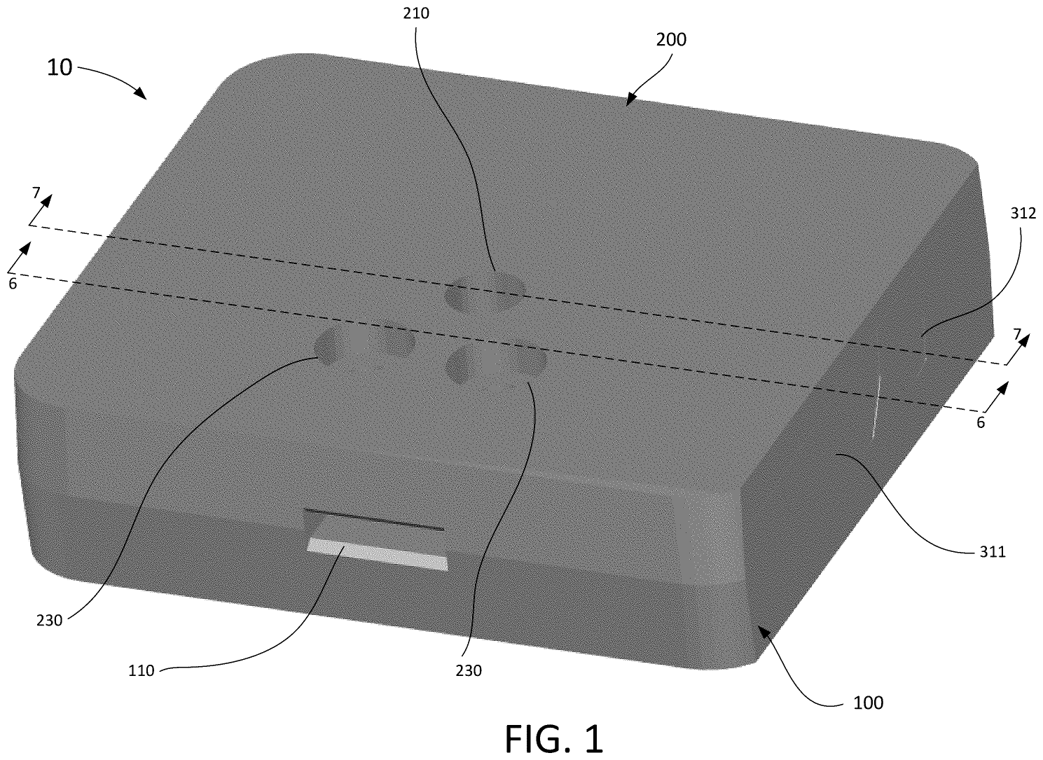

FIG. 1 shows a perspective view of the fully-assembled mold 10, which is shown to include a base 100 and a top 200. The mold 10 is a substantially-rectangular prism and is shaped to be held within (and be compressed by) a clamp when filled with the resin in order to ensure that the resin remains within the mold 10. The mold 10 may include slot 110 in order to help align the mold 10 within the clamp. Three apertures are shown on the surface of the top 200: through-holes 230 extend through the entire depth of the mold 10 and may further assist with holding the mold 10 in place during filling, while passageway 210 is configured to receive the resin (or other material) for ingress into the mold 10 cavity. [symbol] [Kenn and Sam: is there any other purpose to the through-holes 230? In particular, is there any significance to their barbell-like shape?]

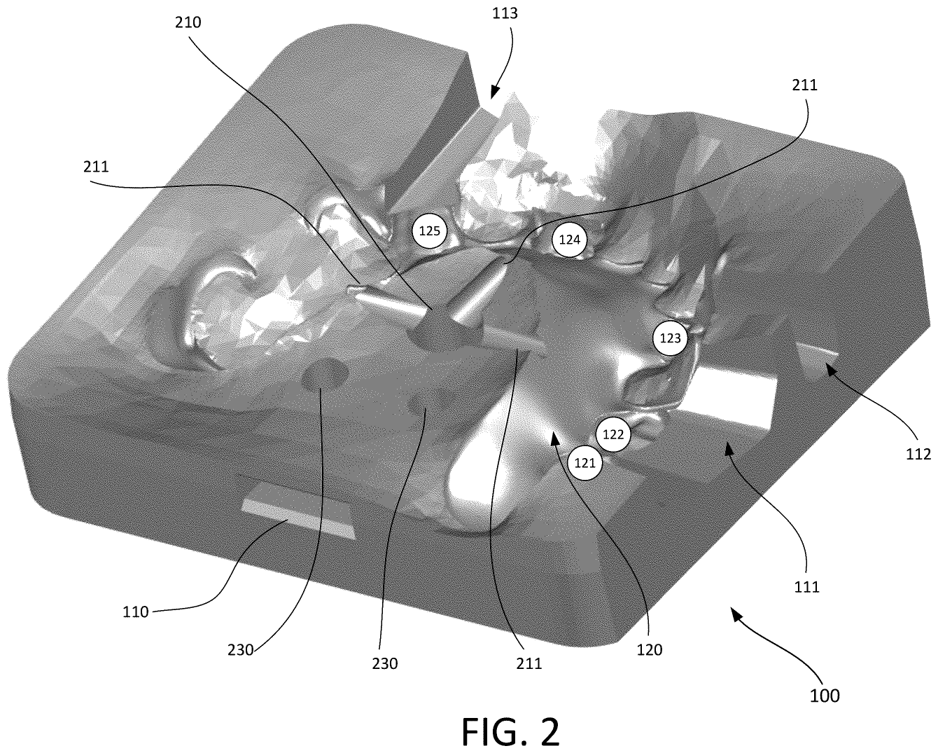

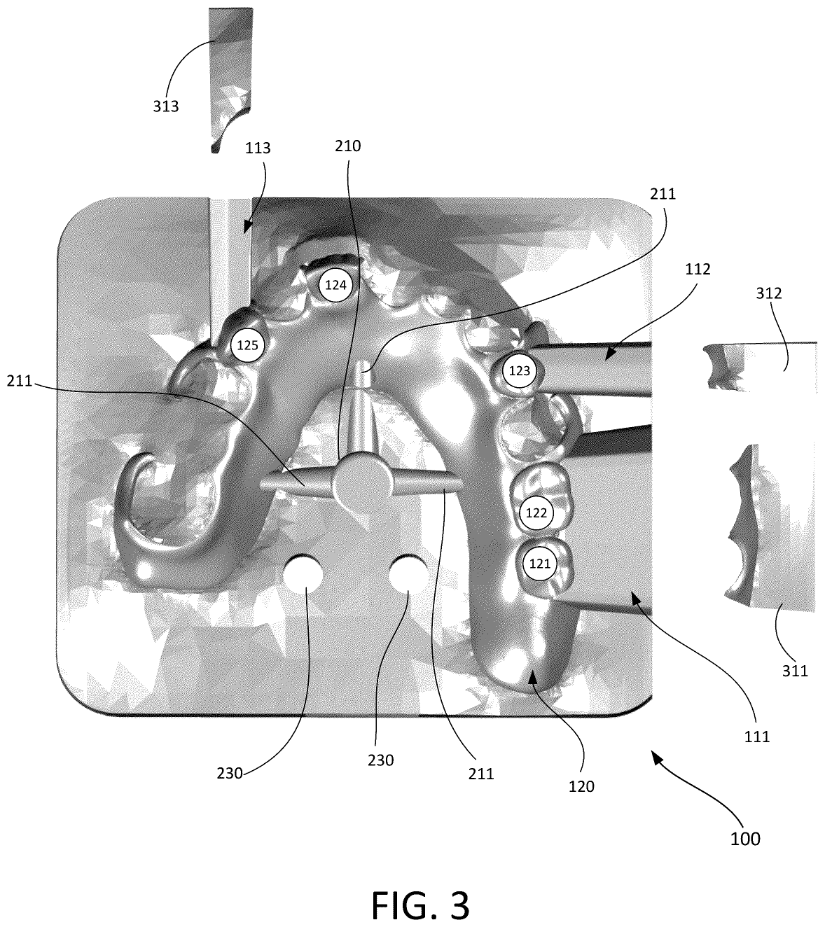

FIGS. 2 and 3 are views of the base 100 of the mold 10. As shown, the base 100 includes a first recess 120 having five indentations: 121, 122, 123, 124, and 125. Each of the five indentations 121-125 is shaped to receive a corresponding artificial tooth. In particular, indentation 121 is shaped to receive artificial tooth 321, indentation 122 is shaped to receive artificial tooth 322, indentation 123 is shaped to receive artificial tooth 323, indentation 124 is shaped to receive artificial tooth 324, and indentation 125 is shaped to receive artificial tooth 325. Although the embodiment shown is shaped to receive five artificial teeth (e.g., for a patient missing five teeth), it should be understood that the disclosure herein should be read to apply for any number of desired artificial teeth. As shown, each of the five indentations may be shaped to receive a crown portion of the artificial tooth, such that a root end of each artificial tooth is exposed when the tooth is positioned within the first recess 120. In some embodiments, the artificial teeth may be formed to include a slot, channel, recess, through-hole, or similar structure on the root portion in order to improve the binding connection between the teeth and the resin, as the structure is shaped to enable the resin to flow within each tooth and harden within the structure.

Teeth are unevenly-shaped and somewhat-bulbous, which can present issues for fitting the artificial teeth within the first recess 120. One solution is to determine the widest point (e.g., the largest-circumference) of the artificial tooth and to define the depth of the first recess 120 such that the widest point of the artificial tooth is positioned at the edge of the first recess 120 (e.g., the depth of the first recess 120 is equal to the longitudinal position of the widest point of the tooth). However, the position of the widest point of each artificial tooth may be different, which means that the depth of the first recess 120 would undulate for each subsequent tooth, creating modeling and manufacturing difficulties.

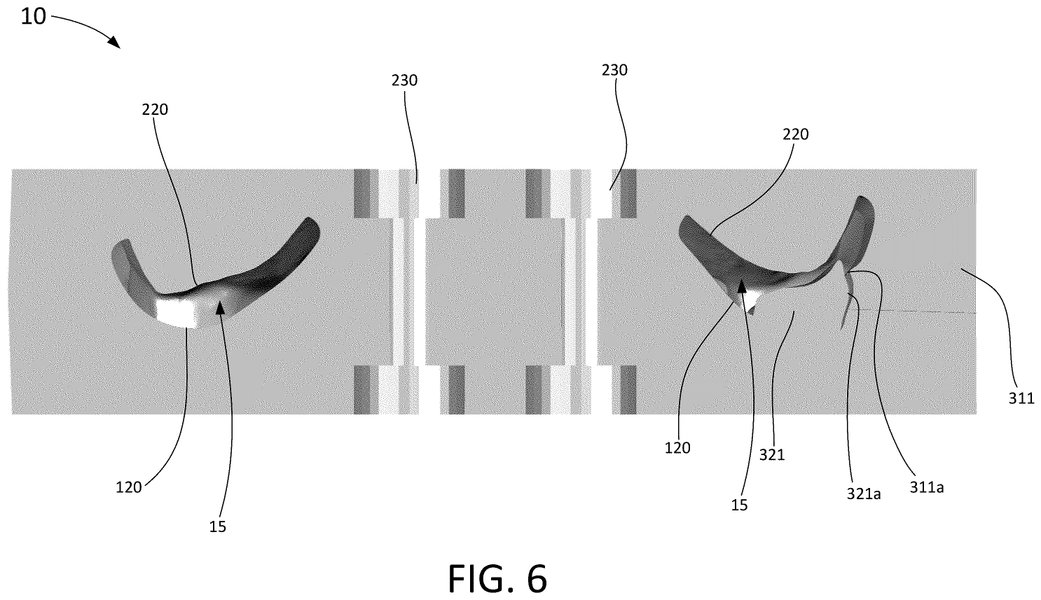

Another solution—which is shown in FIG. 3—is to design slots 111, 112, and 113 that functionally define the edge of the first recess 120 as the widest point of each artificial tooth, and that are shaped to receive corresponding inserts 311, 312, and 313. The inserts, when in position, establish a substantially-flat upper surface for the base 100 to improve the manufacturability of the mold 10. The inserts 311, 312, and 313 may be held in place due to the compressing pressure of the clamp discussed above. As shown, not all artificial teeth may require a slot and corresponding insert in order to be positioned within the first recess 120, and the determination of whether to include the slot and insert may be based on an analysis of the digital model (or rendering) used to manufacture the base 100 (described in greater depth below with reference to FIG. 6).

The passageway 210 is shown to extend into the base 100 and to include three branches 211 that connect the passageway 210 to the first recess 120. Accordingly, when resin (or other appropriate material) flows into the passageway 210, the resin flows through the branches 211 and into the first recess 120. The branches 211 may be sized and shaped to enable the unrestricted flow of resin without negatively-impacting the strength and structural integrity of the mold 10. This resin may be any material suitable for use as a dental appliance and should be sufficiently durable and biocompatible.

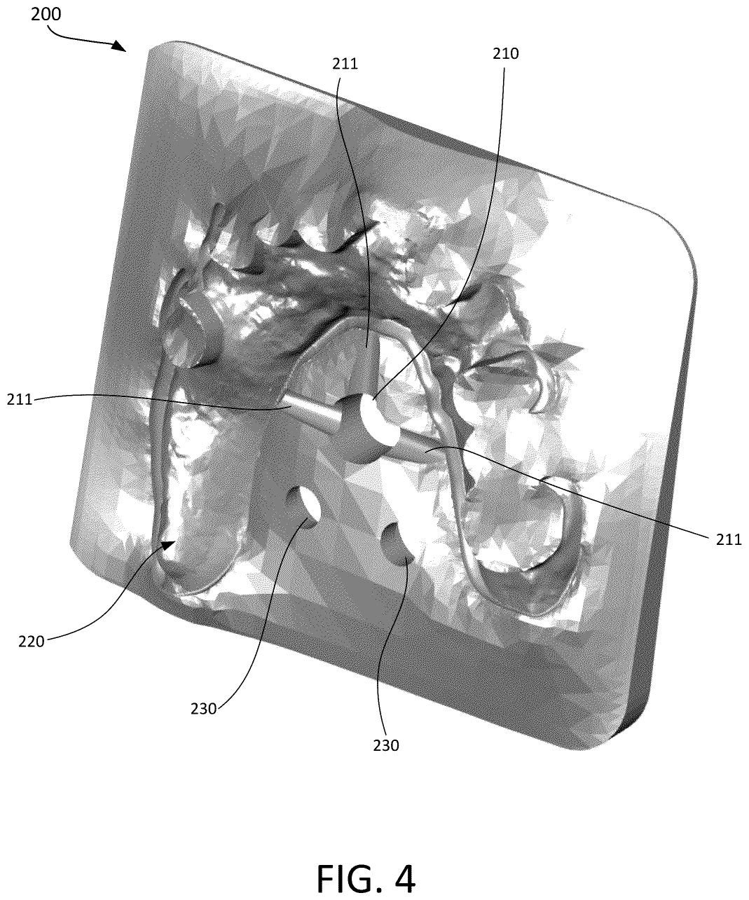

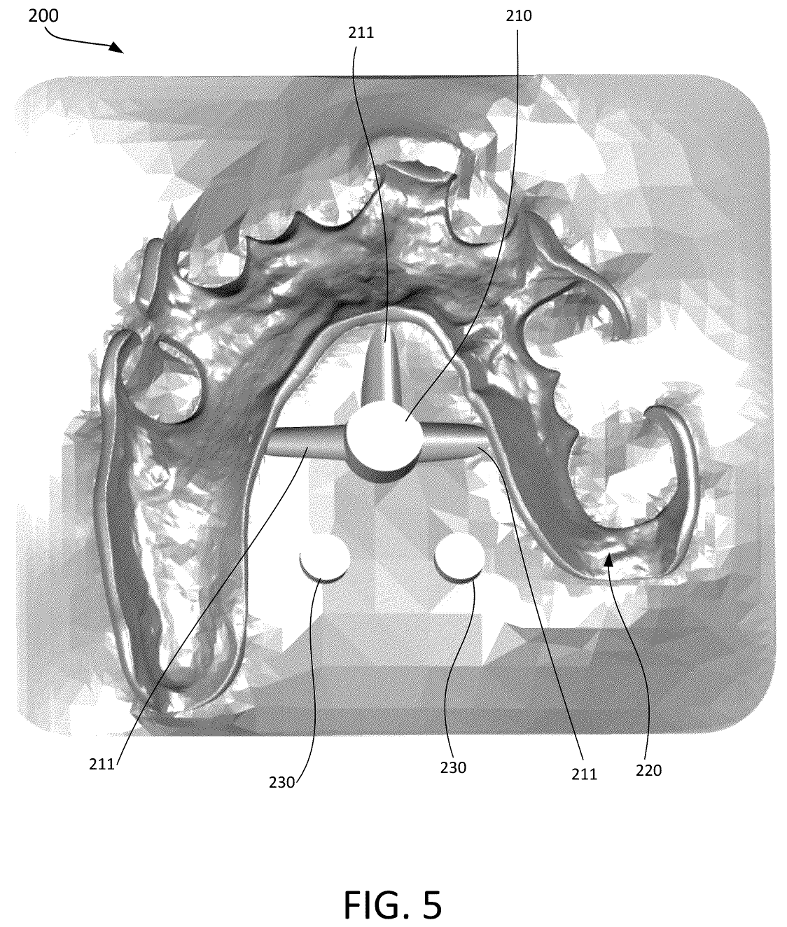

FIGS. 4 and 5 show views of the top 200 of the mold 10. As shown, the top 200 includes a second recess 220 that corresponds to the first recess 120 in shape and position. The second recess 220 is further shaped to snugly fit against the first recess 120 for those portions of the final denture that will correspond to the patient's natural teeth. These portions of the second recess 220 are seen as substantially-cylindrical protrusions and may prevent resin from pooling and hardening at those portions. Furthermore, each of the passageway 210 and both through-holes 230 extend through the top 200, with portions of the branches 211 defined in the top 200 as well.

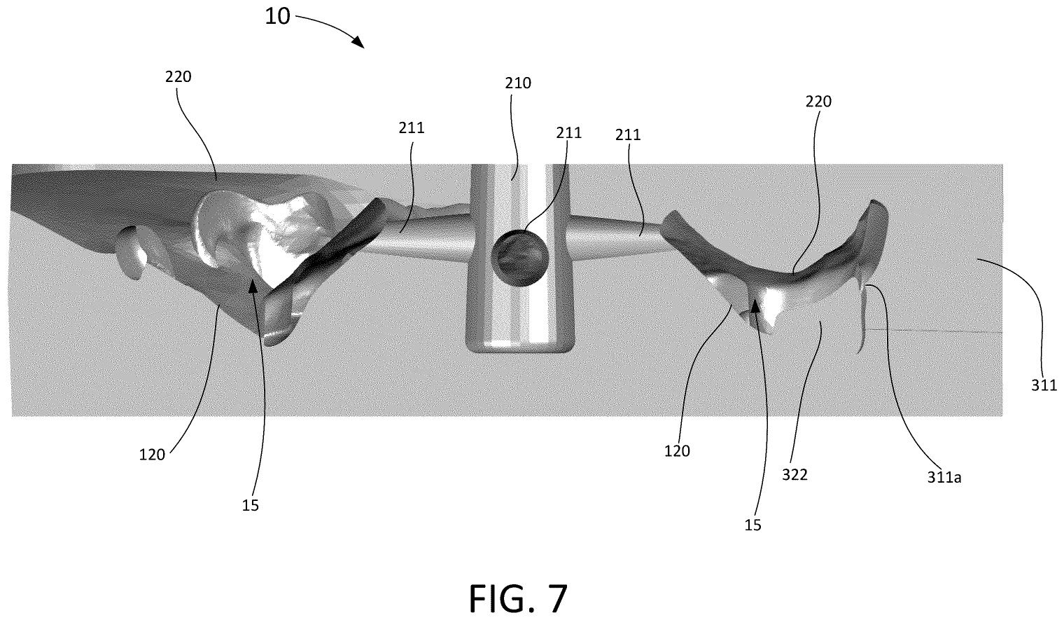

FIGS. 6 and 7 are section views of the mold 10 taken along lines 6-6 and 7-7, respectively. As shown, the first recess 120 and second recess 220 collectively form a cavity 15 when the top 200 and base 100 are mated. FIG. 6 illustrates that the through-holes extend through the entire depth of the mold 10, and FIG. 7 illustrates the position and depth of the passageway 210. FIG. 6 also illustrates the function of the insert 311 as demonstrated by the interaction between overhang 311a and widest point 321a of the artificial tooth 321. Without the insert 311 being formed as a separate component, the first recess 120 would have to be curved to adapt to the bulbous shape of the artificial tooth 321. However, because the base 100 must be structurally rigid in order to withstand the force, pressure, and heat of the injected resin, the base 100 and/or the artificial tooth 321 could be damaged by attempts to insert the tooth 321 into the first recess 120 given that the opening of the first recess 120 would not be wider than the widest point 321a of the tooth 321.

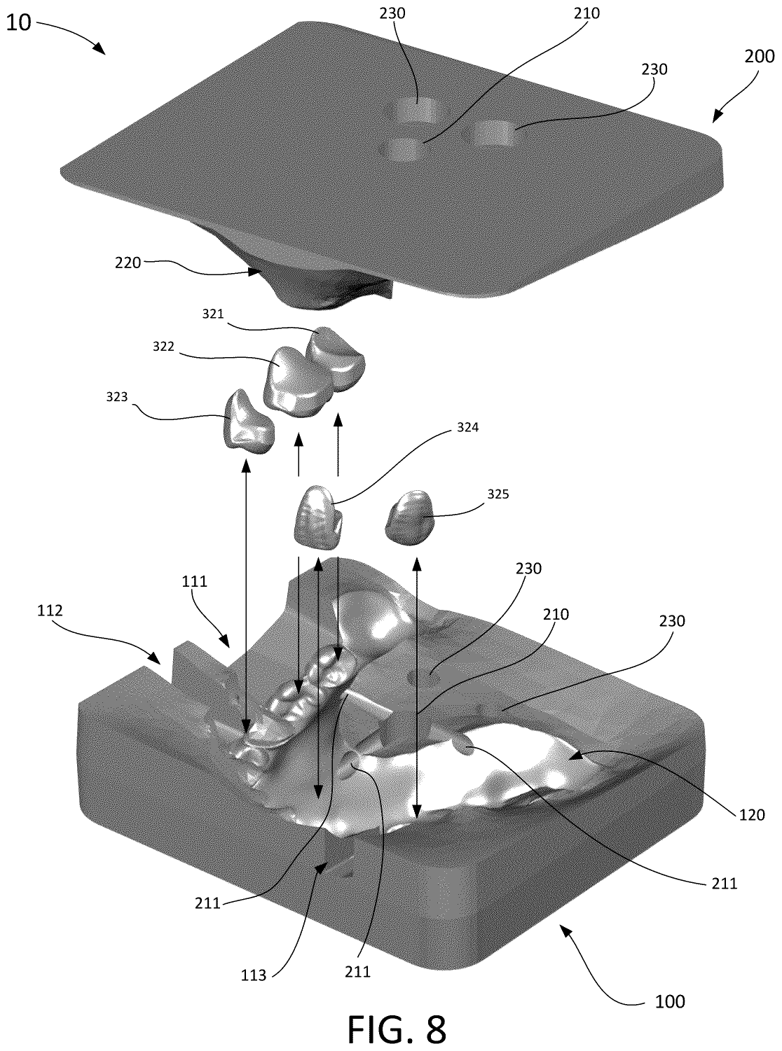

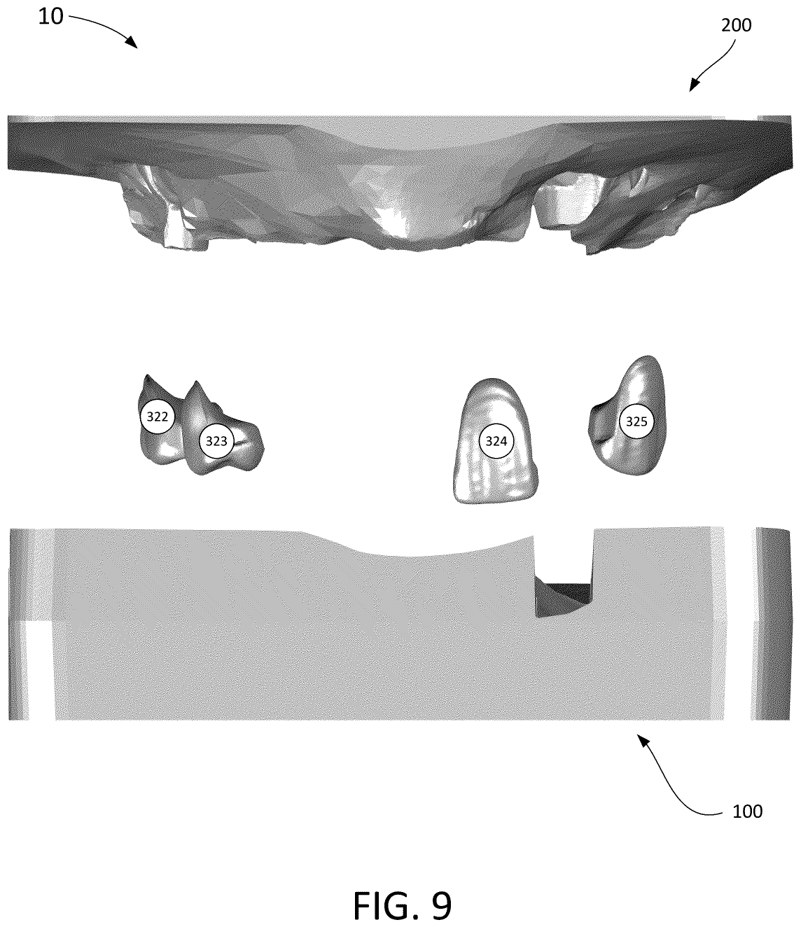

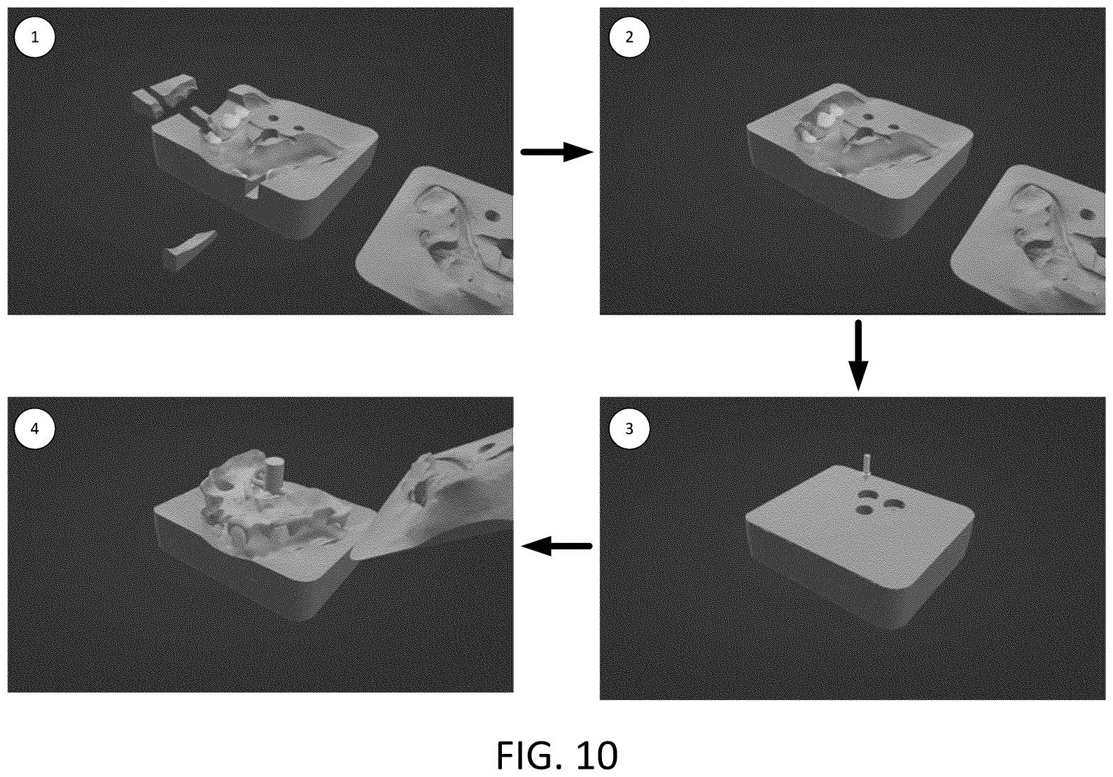

FIGS. 8 and 9 are exploded views of the mold 10 (omitting the inserts 311, 312, and 313 for clarity). FIG. 10 is a process flow showing assembly of the mold 10 and use of the mold 10 to form a partial denture. Panel 1 of FIG. 10 shows the insertion of the artificial teeth into the base 100. Panel 2 of FIG. 10 reflects the final assembly of the base 100 with the positioning of the inserts within the appropriate slots. Panel 3 of FIG. 10 shows the placement of the top 200 onto the assembled base 100, and the injection of resin into the passageway 210 as indicated by the arrow. Panel 4 of FIG. 10 shows the completed partial denture following the removal of the top 200. As shown, the partial denture includes the resin that hardened within the passageway 210 and branches 211, which would be removed in post-processing.

The base 100 and top 200 are additively-manufactured based on a digital model generated based on a digitally-processed (or digitally-enhanced) impression of the patient. First, an impression of the patient's jaw is generated using any suitable and appropriate technique. For example, the impression may be a digital scan that includes the gum portion of the affected jaw, as well as the tooth portion of the affected jaw that includes the natural teeth that remain on the affected jaw. Second, the artificial teeth are digitally added to the model based on the generated impression. At this step, the digital model reflects a full set of teeth as a combination of the natural and artificial teeth. Third, the natural teeth are digitally removed from the digital model. At this step, the digital model reflects the final partial denture (e.g., the resultant appliance). Fourth, the digital model is inverted and defined as the negative space of the digital model from the third step. At this step, the digital model reflects the mold 10 as shown in FIG. 1.

Once the digital model of the mold 10 is completed, the model is processed in order to define the base 100, top 200, and inserts 311-313. The top 200 may be defined by establishing a horizontal plane of an appropriate depth, as well as any amount of the mold 10 that extends from the horizontal plane to an upper bound of the cavity 15. The remaining portion of the mold 10 defines the base 100. From there, the base 100 model may be evaluated according to one or more manufacturing constraints, such as a restriction on overhangs (e.g., overhang 311a) or undercuts, and avoidance of printed supports. For example, some additive manufacturing processes utilize layered-printing methods in which 3D shapes are formed by stacking subsequent layers of material. Because a layer of material, in this method, cannot be printed on air, models intended for use with these methods may add sacrificial supports that provide a platform onto which material can be layered. These sacrificial supports may then be removed in post-processing. However, other additive manufacturing methods, such as selective laser sintering (SLS), remove these overhang/undercut concerns by forming the 3D shape within a reservoir of powder.

In some embodiments—including the one shown in the Figures—an overhang/undercut is necessary to adapt to the artificial teeth. In these embodiments, the base 100 model may be digitally-edited to include a slot and corresponding insert. The position and depth of the slot may be designed such that the bottom of the slot (e.g., the printed edge of the first recess 120) is equal to the depth (e.g., longitudinal position) at which the artificial tooth is widest. The insert is then defined as the amount of material “removed” to accommodate the slot.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of producing a partial denture, comprising:
producing, via additive manufacturing, a first mold portion having a first recess based on a tooth portion of a patient mouth;
producing, via additive manufacturing, a second mold portion having a second recess based on a gum portion of the patient mouth;
positioning at least one artificial tooth in the first recess;
aligning the first mold portion with the second mold portion to form a mold assembly having a cavity defined by the first recess and the second recess;
filling the cavity with a resin; and
removing the partial denture from the mold, the partial denture formed by the resin and the at least one artificial tooth.

2. The method of claim 1, wherein producing the first mold portion comprises:
receiving a digital rendering of the tooth portion, the digital rendering being based on a scan of at least a portion of the patient mouth;
digitally removing at least one natural tooth from, and digitally adding the at least one artificial tooth to, the tooth portion to generate a digitally-enhanced tooth portion; and
producing, with a materials printer, the first mold portion as a negative space of the digitally-enhanced tooth portion.

3. The method of claim 2, wherein producing the first mold portion further comprises:
reviewing the digitally-enhanced tooth portion based on at least one additive manufacturing constraint; and
revising the digitally-enhanced tooth portion to satisfy the at least one additive manufacturing constraint.

4. The method of claim 1, wherein producing the second mold portion comprises:
receiving a digital rendering of the gum portion, the digital rendering being based on a scan of at least a portion of the patient mouth; and
producing, with a materials printer, the second mold portion as a negative space of the gum portion.

5. The method of claim 1, further comprising:
determining a longitudinal position of a largest-circumference portion of the at least one artificial tooth; and
determining a distance from the longitudinal position to a peak of a crown of the at least one artificial tooth;
wherein a depth of the first recess where the at least one artificial tooth is positioned is equal to the determined distance.

6. The method of claim 1, wherein the resin is at least 290° C. during the filling.

7. The method of claim 1, wherein removing the partial denture from the mold comprises breaking the mold.

8. The method of claim 1, wherein the first mold portion and the second mold portion comprise a material capable of withstanding exposure to a temperature of the filled resin up to at least 300° C.

9. The method of claim 1, further comprising:
producing, via additive manufacturing, the at least one artificial tooth.

10. The method of claim 1, wherein the at least one artificial tooth comprises at least one channel configured to receive the resin to mechanically affix the at least one artificial tooth to the partial denture.

11. A system for producing a partial denture, the system comprising:
a first mold portion having a first recess based on a tooth portion of a digital model of a patient mouth;
a second mold portion having a second recess based on a gum portion of the digital model of the patient mouth,
wherein the first recess and the second recess collectively form a mold cavity;
at least one artificial tooth configured to be positioned within in the first recess; and
a resin that, when injected into the mold cavity, binds to the at least one artificial tooth to form the partial denture.

12. The system of claim 11, wherein the first mold portion and the second mold portion are formed via additive manufacturing and comprise a material capable of withstanding a temperature of at least 300° C.

13. The system of claim 12, wherein at least one of the first mold portion or the second mold portion are configured to be broken, without breaking the partial denture, in order to remove the partial denture from the mold cavity.

14. The system of claim 11, wherein at least one of the first mold portion and the second mold portion defines a channel for injecting the resin into the mold cavity.

15. The system of claim 11, wherein the at least one artificial tooth comprises at least one channel configured to receive the resin to mechanically affix the at least one artificial tooth to the partial denture.

16. The system of claim 11, wherein:
the at least one artificial tooth comprises a first artificial tooth and a second artificial tooth;
the first artificial tooth is positioned at a first position within the first recess, the first position having a first depth;
the second artificial tooth is positioned at a second position within the first recess, the second position having a second depth;
the first depth is equal to a distance between a crown of the first artificial tooth and a longitudinal position of a largest-circumference portion of the first artificial tooth;
the second depth is equal to a distance between a crown of the second artificial tooth and a longitudinal position of a largest-circumference portion of the second artificial tooth; and
the first depth is different from the second depth.

17. A method comprising:
receiving a jaw impression of a patient jaw, the jaw impression having a tooth portion and a gum portion;
processing the jaw impression to generate a first digital mold based on negative space of the tooth portion and a second digital mold based on negative space of the gum portion;
producing, via additive manufacturing, a first mold portion based on the first digital mold and a second mold portion based on the second digital mold;
positioning at least one artificial tooth within the first mold portion;
aligning the first mold portion with the second mold portion to form a complete mold having a cavity that corresponds to negative space of the jaw impression;
injecting a resin into the cavity; and
removing a partial denture from the mold, the partial denture formed by the resin and the at least one artificial tooth.

18. The method of claim 17, wherein generating the first digital mold comprises:
digitally removing at least one natural tooth from, and digitally adding the at least one artificial tooth to, the tooth portion of the jaw impression to generate a digitally-enhanced tooth portion; and
defining the first digital mold as negative space of the digitally-enhanced tooth portion.

19. The method of claim 17, wherein the removing the partial denture from the mold comprises breaking the mold.

20. The method of claim 17, further comprising:
determining a longitudinal position of a largest-circumference portion of the at least one artificial tooth; and
determining a distance from the longitudinal position to a peak of a crown of the at least one artificial tooth;
wherein a depth of the first mold portion where the at least one artificial tooth is positioned is equal to the determined distance.
